(19) United States
(12) Patent Application Publication
(10) Pub. No.: US 2019/0037887 A1
(43) Pub. Date: Feb. 7, 2019

(54) FEED SUPPLEMENT PREPARATION AND MANUFACTURING METHOD

(71) Applicant: Axe Agri-Services LLC, Chester, VA (US)

(72) Inventor: Dirk E. Axe, Chester, VA (US)

(21) Appl. No.: 15/670,561

(22) Filed: Aug. 7, 2017

(51) Int. Cl. A23K 20/163; A23K 10/26

(52) U.S. Cl. CPC A23K 20/163; A23K 10/26

(57) ABSTRACT

An animal feed supplement and its preparation method are disclosed. The preparation includes combining a nutritive animal manure ash with a sugar source in a liquid medium or solution. The animal manure ash and sugar source react to solidify to form the animal feed composition.

### FIELD OF THE INVENTION

The present invention relates to an animal feed supplement and in particular an animal feed supplement which is prepared from reactive alkali metals and a sugar-based solution or source.

### BACKGROUND OF THE INVENTION

Dietary supplements, in the form of granular and block, have been recognized for many years as a vehicle to provide homogeneous, convenient, storage stable and weather resistant minerals, vitamins, protein, energy and medicines to animals. During the 1970's and 1980's, chemical processes of preparing such dietary granular and block applications for animals started to proliferate. To date, all of the processes of the prior art involve a step of solidifying products for granular and block animal feed supplement preparations. The chemical process involves a reaction of metal hydroxides and oxides, such as calcium and magnesium, and sugar-based solution or source. Examples include: (1) adding relatively high amounts of calcium or magnesium hydroxide to molasses to prepare a solid feed block; see British Patent No. 1,356,954 of Jun. 19, 1974; (2) reactions between sugar solutions, soluble phosphorus sources and or metal alkalis, such as those disclosed in U.S. Pat. Nos. 4,027,043, 4,160,041, 4,221,818, 4,431,675, 6,440,478 and 6,168,803; (3) forming blocks by mixing under shearing conditions molasses, water, water absorbent clays, magnesium oxide, a water soluble phosphorus source, and animal fat (and optionally a ferrous sulfate), U.S. Pat. Nos. 4,016,296, 4,171,385, 4,171,386 and 4,265,916; (4) producing a solid molasses product by chemical processing method is provided by U.S. Pat. No. 6,440,478 and U.S. Patent Application Publication No. 2008/0113072 (using calcium hydroxide to solidify molasses and fatty acids, and other nutrients and additives, the solid product being in block, particle or powder form); (5) forming a semi-rigid form containing heated molasses, magnesium oxide and dicalcium phosphate (e.g., disclosed in U.S. Pat. Nos. 4,005,192 and 4,234,608); (6) condensing vegetable solubles, such as a nutritive binder, corn steep liquor concentrate, vegetable seed meal, and salt, U.S. Pat. No. 4,349,578; (7) molasses based formula comprising molasses, a trivalent salt of iron, aluminum or chromium, and magnesium oxide as the setting agent. Such formulas are disclosed in U.S. Pat. No. 4,851,244; (8) forming low moisture blocks U.S. Patent Application Publication No. 2014/0272002 used calcium oxide, magnesium oxide and calcium hydroxide combined with molasses and fatty acids to improve block properties and weather resistance; (9) producing buffered animal feed supplement blocks and other preparation is disclosed in U.S. Pat. Nos. 4,729,896; 5,264,227 and 7,718,187 and U.S. Patent Application Publication No. 2014/0186472, buffer comprises at least one of sodium bicarbonate, sodium sesquicarbonate, potassium carbonate, magnesium oxide, magnesium hydroxide, magnesium carbonate, calcium oxide, and calcium hydroxide and sugar source; and (10) suitable pH adjusters that may adjust the pH of compositions or mixtures to an acidic, a neutral or an alkaline pH combined with a sugar source as disclosed in U.S. Pat. No. 4,749,578 and U.S. Patent Application Publication No. 2016/0353770.

### SUMMARY OF THE INVENTION

The present invention relates to an improved animal feed supplement and manufacturing method. Advantageously, the animal feed supplement can be prepared by combining reactive alkali metal compounds present in a nutritive animal manure ash with a sugar source in a liquid solution. The reaction between the nutritive animal manure ash and the sugar source, for example in a liquid solution, occurs rapidly in an exothermic reaction resulting in granular or block material being formed depending on a ratio of the nutritive animal manure ash to the sugar source. Accordingly, the present method provides a simplified process for producing animal feed supplement in granular, powder or block form quickly and without extensive further processing of the addition of additional additives such as calcium hydroxide, calcium oxide, magnesium oxide, etc., as previously required in prior art preparations known in the art including some of those discussed in the Background of the Invention section above.

The nutritive animal manure ash can originate from numerous sources including but not limited to layer-poultry manure ash, broiler-poultry manure ash, turkey-poultry manure ash, poultry manure ash, porcine manure ash, bovine manure ash, equine manure ash, ovine manure ash, caprine manure ash and animal manure ash or mixtures thereof. The sugar source or sugar solution includes but is not limited to molasses (cane or beet origin), corn distillers solubles, corn condensed solubles, brewers condensed solubles, condensed whey, corn steep liquor, lignin sulfonate, sugar/sucrose by-products, separator by-product, soluble molasses solids, soy molasses, wood molasses, starch molasses, citrus molasses, hemicellulose extract, lactose molasses, honey, fruit extracts, sugar, sucrose, fructose (e.g., high fructose corn syrup), glucose, galactose, maltose, lactose, or a mixture thereof.

As noted, the feed supplement degree of hardness and nutrient concentration depends on the ratio of nutritive animal manure ash to the sugar-based solution or source. Based on the ratio, the solidifying composition can be formed into hardened powder, granular and block preparations.

In various forms, the preparation provides one or more of the following features: (1) dry and solid composition; (2) preparations that provide for multiple animal feed supplement applications; (3) inclusion of essential nutrients such as macro minerals, trace minerals, vitamins, protein, energy (including fatty acids) ingredients and medicines; (4) homogeneous nutrient and medicine composition; (5) buffering capacity; (6) pH adjustment; (7) supports improved palatability and consumption; (8) water and weather resistance, durability and stability; (9) improved handling and packaging properties; (10) feed industry acceptance; and (11) economical and value-added preparations.

The present invention, in one form thereof, relates to a method for producing an animal feed composition. The method includes mixing animal manure ash and a sugar source to form a sugar/ash mixture in a liquid solution. The sugar/ash solution mixture is solidified to form the animal feed composition.

In various further embodiments, the method includes mixing a sugar-based solution or source with animal manure ash in a ratio of 5%-40% sugar and 95%-60% nutritive manure ash to form a granular solid composition. If desired, the granular solid composition can be ground into a fine powder.

In an alternative form, the method includes mixing a sugar-based source with animal manure ash by combining 41%-95% sugar with 59%-5% nutritive manure ash to form a block composition.

The present invention also relates to granular, powder and block compositions produced by the aforementioned processes depending on a ratio or percentage of sugar to nutritive manure ash mixed together.

### BRIEF DESCRIPTION OF THE FIGURES

FIG. 1 is a flowchart showing an exemplary process for producing an animal feed supplement preparation in accordance with the present disclosure.

FIG. 2 shows a granular animal feed supplement preparation in accordance with the present invention.

FIG. 3 shows a powder form of an animal feed supplement preparation in accordance with the present disclosure.

FIG. 4 shows a block animal feed supplement preparation in accordance with the present disclosure.

### DETAILED DESCRIPTION OF THE PREFERRED EMBODIMENTS

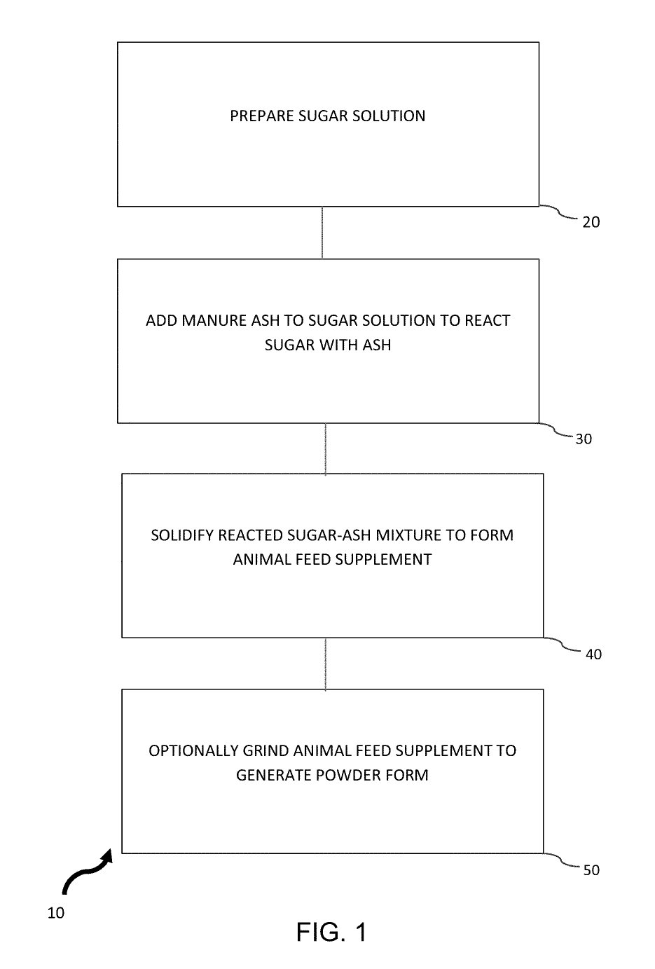

The present invention will now be described with reference to the figures to provide a more thorough understanding of the present animal feed and its preparation. Referring now specifically to FIG. 1, method 10 includes starting with a sugar source. The sugar source can be (1) cane or beet molasses (sugar sources in liquid form) or (2) a granular sugar source, e.g. sucrose, dissolved in water, both (1) and (2) being referred to a sugar-based solution (step 20). Next, animal manure ash is added to the sugar-based solution (step 30). Alternatively, manure ash and a sugar source such as a granular sugar, e.g. sucrose, can be added both in dry form to a liquid, together, or in series to form a combined manure ash/sugar solution rather than first creating a sugar solution and subsequently adding the manure ash to the sugar solution. As a second alternative, a manure ash solution and a sugar source solution can be made separately and then the two solutions combined together. According, mixing animal manure ash and a sugar source together to form a mixture of animal manure ash and sugar, in solution, can occur in any number of different ways which would be understood by one of ordinary skill in the art. Regardless of the extract process or order of steps, combining an animal manure ash and a sugar source, in a liquid solution, produces an animal manure ash/sugar mixture.

The animal manure ash is preferable a nutritive animal manure ash source having reactive alkali metals such as calcium hydroxide, calcium oxide and magnesium oxide, or mixtures thereof. The nutritive animal manure ash, in one advantageous form, is derived from recycling animal manure which is known in the art for use as animal feed, produced from a thermochemical conversion of animal manure. Benefits of the thermochemical conversion process include recovery of sterilized and concentrated inorganic mineral. Thermochemically converted animal manure results in concentrated nutritive mineral compounds with a chemical composition containing reactive alkali metal sources such as calcium hydroxide, calcium oxide and magnesium oxide, or a mixture thereof.

Nutritive animal manure ash can be acquired from the following sources include the following manufacturers, EnergyWorks Biopower, Inc., 71 Old Mill Bottom Road N., Suite 101, Annapolis, Md. 21409; Biomass Heating Solutions, Inc. (BHSL), 1910 Towne Centre Boulevard, Suite 250, Annapolis, Md. 21401; Coaltec Energy USA, Inc., 5749 Coal Drive, Carterville, Ill. 62918; Ecoremedy Energy Technologies, Inc., 180 Silver Spring Road, Mechanicsburg, Pa. 17050; and Global Re-fuel, 7905 CR SW 3170, Winnsboro, Tex. 75494.

Examples of nutritive animal manure ash include but are not limited to the following: layer-poultry manure ash, broiler-poultry manure ash, turkey-poultry manure ash, poultry manure ash, porcine manure ash, bovine manure ash, equine manure ash, ovine manure ash, caprine manure ash and animal manure ash or a mixture thereof.

Suitable sugar-based sources or solutions include but are not limited to the following: molasses (cane or beet origin), corn distillers solubles, corn condensed solubles, brewers condensed solubles, condensed whey, corn steep liquor, lignin sulfonate, sugar/sucrose by-products, separator by-product, soluble molasses solids, soy molasses, wood molasses, starch molasses, citrus molasses, hemicellulose extract, lactose molasses, honey, fruit extracts, sugar, sucrose, fructose (e.g., high fructose corn syrup), glucose, maltose, lactose, and galactose or a mixture thereof.

When the animal manure ash and sugar source are combined together in solution, a reaction between the sugar source and the alkali metals in the nutritive animal manure ash, in an exothermic chemical reaction, to produce calcium and magnesium based carbohydrates, or a mixture thereof. The amount of liquid in the solution of manure ash and sugar source is advantageously kept to a sufficiently minimal amount resulting in quick reactivity between the sugar and alkali metal source in the manure ash resulting in formation of granular or a solid material depending on the ratio of manure ash to sugar in solution (step 40). If desired, during the solidifying step, heat can be applied as desired to accelerate the process (step 40). For example, the sugar-ash mixture can be heated to a temperature of 75 to 105° C. (step 40).

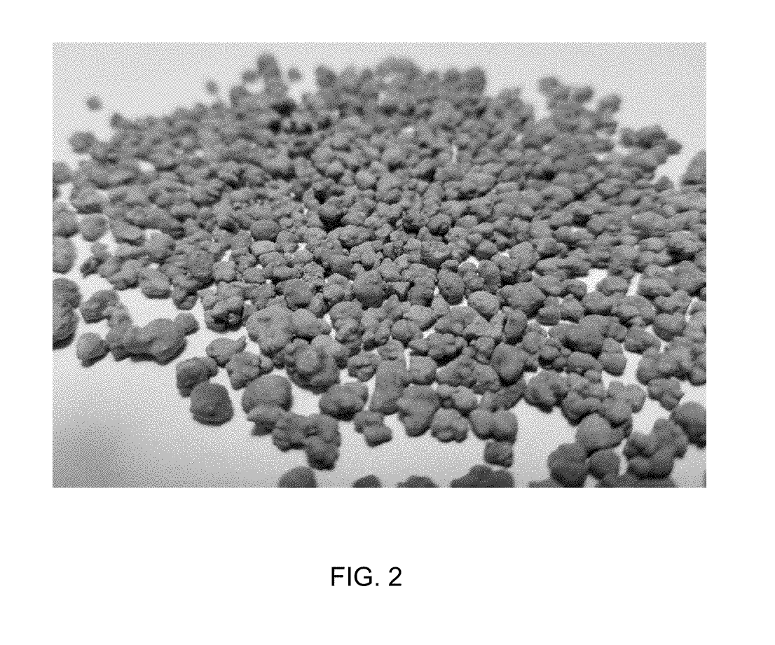

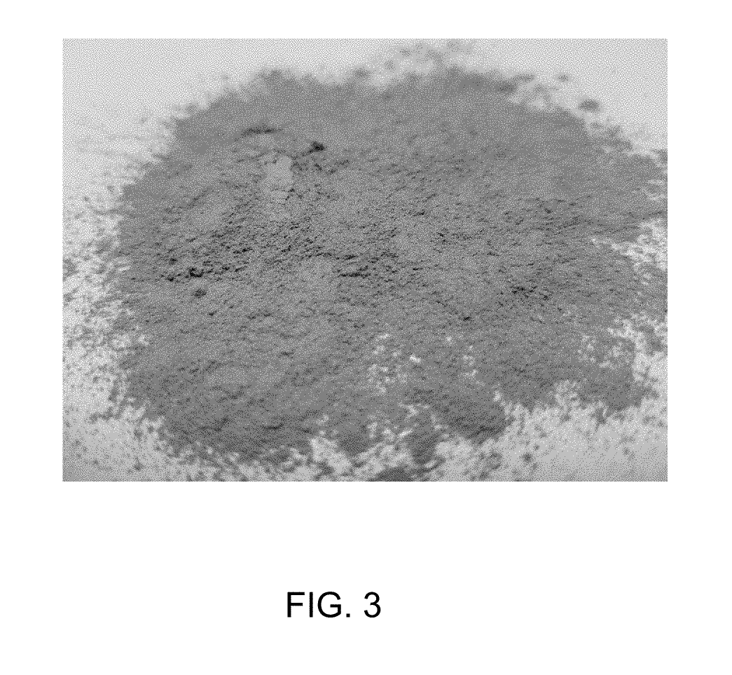

A solid granular animal feed supplement results when 95%-60% nutritive manure ash to 5%-40% sugar such as cane molasses is used. FIG. 2 shows granular particles of the animal feed supplement produced. If desired, the granules can be ground to produce a fine powder as shown in FIG. 3 (step 50, FIG. 1).

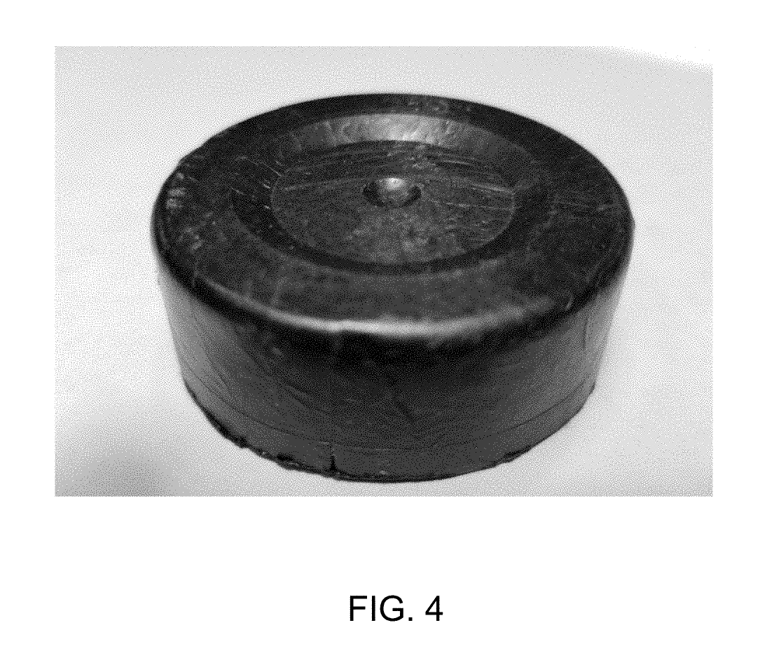

A block form animal feed supplement is produced when ratios from 59%-5% nutritive animal manure ash to 41%-95% sugar such as cane molasses are mixed together. FIG. 4 shows a block animal feed supplement produced with these ratios.

The following table identifies properties of an animal feed preparation produced from various ratios of sugar and nutritive animal manure ash (“mineral”):

Nutritive Animal Manure Ash to Sugar-Based Source
(Cane Molasses) Ratio for Preparation of Products
Total Mix - 227 Grams

| Cane Molasses | | Manure Ash | | |
|---|---|---|---|---|
| % in mix | Grams in mix | % in mix | Grams in mix | Preparation |
| 5 | 11 | 95 | 216 | Granular |
| 10 | 23 | 90 | 204 | Granular |
| 20 | 45 | 80 | 182 | Granular |
| 30 | 68 | 70 | 159 | Granular |
| 40 | 91 | 60 | 136 | Granular |
| 50 | 113 | 50 | 114 | Block |
| 60 | 136 | 40 | 91 | Block |
| 70 | 159 | 30 | 68 | Block |
| 80 | 182 | 20 | 45 | Block |
| 90 | 204 | 10 | 23 | Block |
| 95 | 216 | 5 | 11 | Block |

### EXAMPLES

The following non-limiting examples are provided to enhance further understanding of the present preparation and animal feed supplement.

### Example 1

### Preparation of Mineral Feed Supplement for Animals in Granular Form

Mix composition of nutritive animal manure ash with sugar-based solution or source. Cane molasses was used as the sugar-based solution or source. Nutritive animal manure ash (151 grams) was mixed with cane molasses (75 grams of a 5% water-diluted mixture). Addition of water to cane molasses resulted in a reduction in viscosity and improvement in application properties. The homogeneous composition reacts and starts to solidify (less than 3 minutes) under ambient temperature conditions into various size particles during the mixing process. Mixing for a longer period of time resulted in larger granules being formed. Granules were air-dried at ambient temperature to allow for curing and hardening which occurred over a 24 hour period after processing. Although heating sugar-based solution or source prior to mixing the composition is not required, it will increase rate of solidification.

The process can vary in the concentration of nutritive animal manure ash and sugar-based solution or source to generate particle preparation. Ratios from 95%-60% nutritive animal manure ash to 5%-40% cane molasses results in rapid particle formation upon mixing of the composition. Mixing ratios that are higher in sugar-based solution or source will require more time for curing and hardening of particles.

A heat-drying process or step is not required of final composition preparation. However, applying heat (e.g. between 75 to 105° C.) will accelerate the solidification process. Particles can be screened to separate product into small, medium or large particles depending on best-fit for a specific animal feed application. Particles (e.g., as shown in FIG. 2) can be ground into powder form if animal application requires an ultra-fine particle size as shown in FIG. 3. As the composition will have an alkaline pH value, pH value of composition can be adjusted by addition of inorganic or organic acid, anhydrous salt and sugar-based solution and source, or a mixture thereof, during the mixing process to reduce pH value of composition. Reactive alkali metal compounds, or a mixture thereof, can be added to enhance solidification properties of the final composition.

### Example 2

### Preparation of Mineral Feed Supplement for Animals in Block Form

Mix composition of nutritive animal manure ash with sugar-based solution or source. Cane molasses was used as the sugar-based solution or source. Nutritive animal manure ash (121 grams) was mixed with cane molasses (106 grams). The homogeneous composition reacts and starts to solidify (less than 3 minutes) under ambient temperature conditions into a solid mass during the mixing process. The solid mass was allowed to solidify in a plastic container used for mixing the composition and formation of the block. The composition was air-dried at ambient temperature to allow for curing and hardening of block which occurred over a 72 hour period after processing. Heating sugar-based solution or source prior to mixing the composition is not required. However, heating the solution or source will increase rate of solidification.

The process can vary in the concentration of nutritive animal manure ash and sugar-based solution or source to generate block preparation. Ratios from 59%-5% nutritive animal manure ash to 41%-95% cane molasses results in block formation, see, e.g., FIG. 4. Mixing ratios that are higher in sugar-based solution or source will require more time for curing and hardening of blocks. Furthermore, the mixing ratios can impact the hardness of the block. Higher levels of added nutritive animal manure ash relative to sugar-based solution or source will generate harder blocks. Although heat-drying process is not required of final composition preparation it can accelerate the solidification process. Blocks can be ground into powder form if animal application requires an ultra-fine particle size.

As the composition will have an alkaline pH value, pH value of composition can be adjusted by addition of inorganic or organic acid, anhydrous salt and sugar-based solution and source, or a mixture thereof, during the mixing process to reduce pH value of final composition. Reactive alkali metal compounds, or a mixture thereof, can be added to enhance solidification properties of the final composition.

### Example 3

### Preparation of Mineral Feed Supplement for Animals in Granular Form (Added Mineral Ingredients)

The present method allows for a composition of nutritive animal manure ash with the addition of mineral, vitamin, medicine, protein and energy (including fatty acids) ingredients, or a mixture thereof, with sugar-based solution or source. In this particular example, the composition was nutritive animal manure ash and mineral ingredients, or a mixture thereof, with sugar-based solution or source. Cane molasses was used as the sugar-based solution or source. Nutritive animal manure ash (136 grams) was mixed with monocalcium phosphate (10 grams), salt (5 grams) and potassium/magnesium sulfate (5 grams). The dry mixed composition was then mixed with cane molasses (90 grams of a 5% water-diluted mixture). Addition of water to cane molasses resulted in a reduction in viscosity and improvement in application properties. The homogeneous composition reacts and starts to solidify (less than 3 minutes) under ambient temperature conditions into various size particles during the mixing process. Mixing for a longer period of time resulted in larger granules being formed. Granules were air-dried at ambient temperature to allow for curing and hardening which occurred over a 24 hour period after processing. Although heating sugar-based solution or source prior to mixing the composition is not required, it will increase rate of solidification.

The process can vary in the concentration of nutritive animal manure ash, mineral ingredients and sugar-based solution or source to generate particle preparation. Ratios from 95%-60% nutritive animal manure ash to 5%-40% cane molasses results in rapid particle formation upon mixing of the composition. Mixing ratios that are higher in sugar-based solution or source will require more time for curing and hardening of particles. Although heat-drying process is not required of final composition preparation it will accelerate the solidification process. Particles can be screened to separate product into small, medium or large particles depending on best-fit for a specific animal feed application. Particles, which will have an appearance similar to those produced in Example 1, as shown in FIG. 2, can be ground into powder form if animal application requires an ultra-fine particle size having an appearance similar to those from Example 1, shown in FIG. 3. As the composition will have an alkaline pH value, pH value of composition can be adjusted by addition of inorganic or organic acid, anhydrous salt and sugar-based solution and source, or a mixture thereof, during the mixing process to reduce pH value of composition. Reactive alkali metal compounds, or a mixture thereof, can be added to enhance solidification properties of the final composition.

### Example 4

### Preparation of Mineral Feed Supplement for Animals in Block Form (Added Mineral Ingredients)

The present method allows for a composition of nutritive animal manure ash with the addition of mineral, vitamin, medicine, protein and energy (including fatty acids) ingredients, or a mixture thereof, with sugar-based solution or source. In this particular example, the composition is nutritive animal manure ash and mineral ingredients, or a mixture thereof, with sugar-based solution or source. Cane molasses was used as the sugar-based solution or source. Nutritive animal manure ash (105 grams) was mixed with monocalcium phosphate (15 grams), salt (10 grams) and potassium/magnesium sulfate (7 grams). The dry mixed composition was then mixed with cane molasses (123 grams). The homogeneous composition reacts and starts to solidify (less than 3 minutes) under ambient temperature conditions into a solid mass during the mixing process. The solid mass was allowed to solidify in a plastic container used for mixing the composition and formation of the block. The composition was air-dried at ambient temperature to allow for curing and hardening of block which occurred over a 72 hour period after processing. Although heating sugar-based solution or source prior to mixing the composition is not required, it will increase rate of solidification.

The process can vary in the concentration of nutritive animal manure ash, mineral ingredients and sugar-based solution or source to generate block preparation. Ratios from 59%-5% nutritive animal manure ash to 41%-95% cane molasses results in block formation having an appearance similar to the block from Example 2, shown in FIG. 4. Mixing ratios that are higher in sugar-based solution or source will require more time for curing and hardening of blocks. Furthermore, the mixing ratios can impact the hardness of the block. Higher levels of added nutritive animal manure ash relative to sugar-based solution or source will generate harder blocks. Although heat-drying process is not required of final composition preparation it can accelerate the solidification process. Blocks can be ground into powder form if animal application requires an ultra-fine particle size.

As the composition will have an alkaline pH value, pH value of composition can be adjusted by addition of inorganic or organic acid, anhydrous salt and sugar-based solution and source, or a mixture thereof, during the mixing process to reduce pH value of final composition. Reactive alkali metal compounds, or a mixture thereof, can be added to enhance solidification properties of the final composition.

### Example 5

### Preparation of Multi-Nutrient Feed Supplement for Animals in Granular Form (Added Energy (Including Fatty Acids), Protein and Mineral Ingredients)

The present method can be adapted to produce a composition of nutritive animal manure ash with the addition of mineral, vitamin, medicine, protein and energy (including fatty acids) ingredients, or a mixture thereof, with a sugar-based solution or source. In this particular example, the composition is nutritive animal manure ash and energy (including fatty acids), protein and mineral ingredients, or a mixture thereof, with sugar-based solution or source. Cane molasses was used as the sugar-based solution or source. Nutritive animal manure ash (136 grams) was mixed with corn meal (10 grams), wheat flour (10 grams), flaxseed (5 grams), monocalcium phosphate (10 grams) and salt (5 grams). Cane molasses (90 grams) and fatty acids (5 grams) were mixed and heated to 80° C. The fatty acids can be those disclosed in the animal feed in U.S. Pat. Nos. 4,803,085, 4,826,694, 5,236,717, and 7,645,471 (herein incorporated by reference) or other suitable fatty acids for incorporation in animal feed known to one of ordinary skill in the art. The purpose of heating the cane molasses with fatty acids was to combine and improve application of liquids. The dry and liquid compositions were mixed. The homogeneous composition reacts and starts to solidify (less than 3 minutes) under ambient temperature conditions into various size particles during the mixing process. Mixing for a longer period of time resulted in larger granules being formed. Granules were air-dried at ambient temperature to allow for curing and hardening which occurred over a 24 hour period after processing.

The process can vary in the concentration of nutritive animal manure ash, energy (including fatty acids), protein and mineral ingredients and sugar-based solution or source to generate particle preparation. Ratios from 95%-60% nutritive animal manure ash to 5%-40% cane molasses results in rapid particle formation upon mixing of the composition. Mixing ratios that are higher in sugar-based solution or source will require more time for curing and hardening of particles. Although heat-drying process is not required of final composition preparation it will accelerate the solidification process. Particles can be screened to separate product into small, medium or large particles depending on best-fit for a specific animal feed application. Particles will have an appearance similar to the ones produced in Example 1 and shown in FIG. 2. These particles can be ground into powder form if animal application requires an ultra-fine particle size, which will look similar to the powder from Example 1, shown in FIG. 3.

As the composition will have an alkaline pH value, pH value of composition can be adjusted by addition of inorganic or organic acid, anhydrous salt and sugar-based solution and source, or a mixture thereof, during the mixing process to reduce pH value of composition. Reactive alkali metal compounds, or a mixture thereof, can be added to enhance solidification properties of the final composition.

### Example 6

### Preparation of Multi-Nutrient Feed Supplement for Animals in Block Form (Added Energy (Including Fatty Acids), Protein and Mineral Ingredients)

The present method can be adapted to produce a composition of nutritive animal manure ash with the addition of mineral, vitamin, medicine, protein and energy (including fatty acids) ingredients, or a mixture thereof, with sugar-based solution or source. In this particular example, the composition was nutritive animal manure ash and energy (including fatty acids), protein and mineral ingredients, or a mixture thereof, with sugar-based solution or source. Cane molasses was used as the sugar-based solution or source. Nutritive animal manure ash (105 grams) was mixed with corn meal (21 grams), wheat flour (20 grams), flaxseed (12 grams), monocalcium phosphate (15 grams) and salt (10 grams). Cane molasses (123 grams) and fatty acids (5 grams) were mixed and heated to 80° C. The fatty acids can be those disclosed in the animal feed in U.S. Pat. Nos. 4,803,085, 4,826,694, 5,236,717, and 7,645,471 (herein incorporated by reference) or other suitable fatty acids for incorporation in animal feed known to one of ordinary skill in the art. The purpose of heating the cane molasses with fatty acids was to combine and improve application of liquids. The dry and liquid compositions were mixed. The homogeneous composition reacts and starts to solidify (less than 3 minutes) under ambient temperature conditions into a solid mass during the mixing process. The solid mass was allowed to solidify in a plastic container used for mixing the composition and formation of the block. The composition was air-dried at ambient temperature to allow for curing and hardening of block which occurred over a 72 hour period after processing. Although heating sugar-based solution or source prior to mixing the composition is not required, it will increase rate of solidification.

The process can vary in the concentration of nutritive animal manure ash, energy (including fatty acids), protein and mineral ingredients and sugar-based solution or source to generate particle preparation. Ratios from 59%-5% nutritive animal manure ash to 41%-95% cane molasses results in block formation, which will appear similar to the block in FIG. 4 from Example 2. Mixing ratios that are higher in sugar-based solution or source will require more time for curing and hardening of blocks. Furthermore, the mixing ratios can impact the hardness of the block. Higher levels of added nutritive animal manure ash relative to sugar-based solution or source will generate harder blocks. Although heat-drying process is not required of final composition preparation it can accelerate the solidification process. Blocks can be ground into powder form if animal application requires an ultra-fine particle size. As the composition will have an alkaline pH value, pH value of composition can be adjusted by addition of inorganic or organic acid, anhydrous salt and sugar-based solution and source, or a mixture thereof, during the mixing process to reduce pH value of final composition. Reactive alkali metal compounds, or a mixture thereof, can be added to enhance solidification properties of the final composition.

### Example 7

### Preparation of Coating Product for Animal Feeds

Cane molasses (155 grams) was mixed with fatty acids (45 grams) and nutritive animal manure ash (7.3 grams). The fatty acids can be those disclosed in the animal feed in U.S. Pat. Nos. 4,803,085, 4,826,694, 5,236,717, and 7,645,471 (herein incorporated by reference) or other suitable fatty acids for incorporation in animal feed known to one of ordinary skill in the art. The composition was mixed and heated to 100° C. for 20 minutes to form a homogeneous liquid containing a molasses and fatty acid calcium salt product. This homogenous liquid (i.e. a coating preparation) was uniformly applied on to the surface of feed granules and allowed to harden at room temperature for 5 hours. The coating product formed a hardened coating covering the surface of the feed granules.

Although the invention has been described above in relation to preferred embodiments thereof, it will be understood by those skilled in the art that variations and modifications can be effected in these preferred embodiments without departing from the scope and spirit of the invention.

1. A method for producing an animal feed supplement composition, the method comprising:
mixing nutritive animal manure ash and a sugar source, wherein one or both the animal manure ash and the sugar source are in solution, to form a sugar/ash mixture in solution; and
solidifying the sugar/ash mixture to form the animal feed supplement composition.

2. The method of claim 1, wherein the solidifying the sugar/ash mixture occurs at ambient temperature.

3. The method of claim 1, wherein the solidifying the sugar/ash mixture comprises heating the mixture to a temperature in a range of 75 to 105° C.

4. The method of claim 1, wherein the animal manure is layer-poultry manure ash.

5. The method of claim 1, wherein the sugar source is cane molasses.

6. The method of claim 1, wherein mixing a sugar-based source solution with animal manure ash to form a sugar/ash mixture comprises producing a solution comprising 5%-40% sugar and 95%-60% nutritive animal manure ash to form a granular solid composition.

7. The method of claim 6, further comprises grinding the granular solid composition into a powder.

8. The method of claim 1, wherein mixing a sugar-based source solution with animal manure ash to form a sugar/ash mixture comprises producing a solution comprising 41%-95% sugar and 59%-5% nutritive manure ash to form a block composition.

9. The animal feed composition produced by the method of claim 1.

10. The animal feed composition produced by the method of claim 6.

11. The animal feed composition produced by the method of claim 7.

12. The animal feed composition produced by the method of claim 8.

13. The method of claim 1, wherein the animal manure ash comprises one or more alkali metal compounds selected from the group consisting of calcium hydroxide, calcium oxide, magnesium oxide and mixtures thereof.

14. An animal feed composition comprising:
nutritive animal manure ash and a sugar source,
wherein the sugar source and nutritive animal manure ash are solidified to form the animal feed composition.

15. A method for producing an animal feed composition, the method comprising:
combining a nutritive animal manure ash and a sugar source, in a liquid solution, wherein the solution with nutritive animal manure ash form a sugar/ash mixture; and
solidifying the sugar/ash mixture to form the animal feed composition.
